(19) United States
(12) Patent Application Publication
(10) Pub. No.: US 2025/0348356 A1
(43) Pub. Date: Nov. 13, 2025

(54) AUTOMATED RESOURCE FORECASTING USING STATISTICAL ANALYSIS AND MACHINE LEARNING TECHNIQUES

(71) Applicant: Dell Products L.P., Round Rock, TX (US)

(72) Inventors: Renold Raj Deveraj, Bengaluru (IN); Jeannie Fitzgerald, Ennis (IE)

(21) Appl. No.: 18/661,052

(22) Filed: May 10, 2024

(51) Int. Cl. G06F 9/50

(52) U.S. Cl. CPC G06F 9/5011; G06F 2209/5019

(57) ABSTRACT

Methods, apparatus, and processor-readable storage media for automated resource forecasting using statistical analysis and machine learning techniques are provided herein. An example computer-implemented method includes segmenting resource demand time series data, for at least one resource, into segments based on at least one resource demand level threshold; determining at least one probability distribution that fits at least a plurality of the segments using one or more statistical analyses; generating forecasts for two or more of the segments for at least one future time period based on the at least one probability distribution; generating a resource demand forecast for the at least one resource by aligning the forecasts for the two or more of the segments to at least one time index associated with the at least one future time period using one or more machine learning techniques; and performing one or more automated actions based on the resource demand forecast.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Resource demand forecasting can provide inputs to various resource-related activities, security and/or risk evaluations, etc. However, conventional resource forecasting techniques typically fail to capably forecast resources associated with irregularities with respect to time and/or demand quantity, leading to errors, inaccuracies, and resource wastage and/or loss.

### SUMMARY

Illustrative embodiments of the disclosure provide techniques for automated resource forecasting using statistical analysis and machine learning techniques.

An exemplary computer-implemented method includes segmenting resource demand time series data, for at least one resource, into multiple segments based on at least one resource demand level threshold, and determining at least one probability distribution that fits at least a plurality of the multiple segments using one or more statistical analyses. The method also includes generating forecasts for two or more of the multiple segments for at least one future time period based at least in part on the at least one probability distribution, and generating a resource demand forecast for the at least one resource for the at least one future time period by aligning the forecasts for the two or more of the multiple segments to at least one time index associated with the at least one future time period using one or more machine learning techniques. Further, the method additionally includes performing one or more automated actions based at least in part on the resource demand forecast.

Illustrative embodiments can provide significant advantages relative to conventional resource forecasting techniques. For example, problems associated with errors, inaccuracies, and resource wastage and/or loss are overcome in one or more embodiments through automatically generating resource demand forecasts using a combination of statistical analysis and machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated resource forecasting using statistical analysis and machine learning techniques in an illustrative embodiment.

FIG. 2 shows an example workflow in an illustrative embodiment.

FIG. 3 shows example pseudocode for processing distribution models in an illustrative embodiment.

FIG. 4 shows example pseudocode for validating forecasting predictions in an illustrative embodiment.

FIG. 5 shows an example workflow in an illustrative embodiment.

FIG. 6 is a flow diagram of a process for automated resource forecasting using statistical analysis and machine learning techniques in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

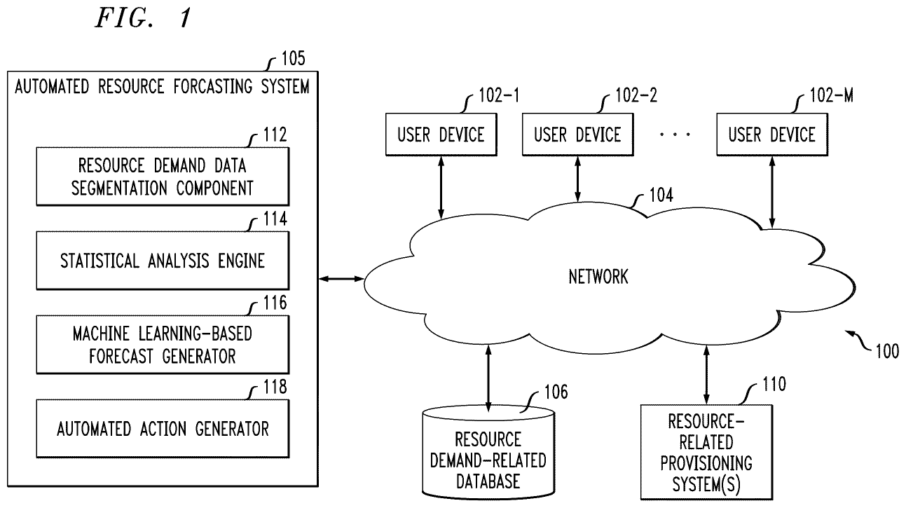

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource forecasting system 105 and one or more resource-related provisioning systems 110 (e.g., one or more resource manufacturing systems, one or more resource transmission systems, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated resource forecasting system 105 can have an associated resource demand-related database 106 configured to store data pertaining to resource demand data for various resources across various temporal periods.

The resource demand-related database 106 in the present embodiment is implemented using one or more storage systems associated with the automated resource forecasting system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated resource forecasting system 105 are one or more input-output devices, which illustratively comprise keyboards, displays or other types of input-output devices in any combination. Such input-output devices can be used, for example, to support one or more user interfaces to the automated resource forecasting system 105, as well as to support communication between the automated resource forecasting system 105 and other related systems and devices not explicitly shown.

Additionally, the automated resource forecasting system 105 in the FIG. 1 embodiment is assumed to be implemented using at least one processing device. Each such processing device generally comprises at least one processor and an associated memory, and implements one or more functional modules for controlling certain features of the automated resource forecasting system 105.

More particularly, the automated resource forecasting system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated resource forecasting system 105 to communicate over the network 104 with the user devices 102, and illustratively comprises one or more conventional transceivers.

The automated resource forecasting system 105 further comprises resource demand data segmentation component 112, statistical analysis engine 114, machine learning-based forecast generator 116, and automated action generator 118.

It is to be appreciated that this particular arrangement of elements 112, 114, 116 and 118 illustrated in the automated resource forecasting system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of the elements 112, 114, 116 and 118 may be implemented at least in part in the form of software that is stored in memory and executed by a processor.

It is to be understood that the particular set of elements shown in FIG. 1 for automated resource forecasting using statistical analysis and machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated resource forecasting system 105, resource demand-related database 106, and resource-related provisioning system(s) 110 can be on and/or part of the same processing platform.

An exemplary process utilizing elements 112, 114, 116 and 118 of an example automated resource forecasting system 105 in computer network 100 will be described in more detail with reference to the flow diagram of FIG. 6.

Accordingly, at least one embodiment includes automated resource forecasting using statistical analysis and machine learning techniques. More particularly, as further detailed herein, such an embodiment includes implementing adaptive statistical resource demand forecasting. Additionally, one or more embodiments include leveraging statistical principles of curve fitting and time continuity in generating and/or implementing at least one interpretable forecasting model that can forecast resource demand for multiple quantities at multiple temporal intervals (e.g., at a daily, weekly and/or monthly level). Such an embodiment can provide flexibility to handle various demand patterns and/or time series patterns, as well as the ability to handle model irregularities with respect to time and resource quantities associated with historical data.

At least one embodiment includes implementing series segmentation coupled with distribution fitting, in connection with leveraging one or more foundational statistical principles. As used herein, demand forecasting refers to the prediction of future resource demand based at least in part on historical data and one or more other relevant factors. Additionally, as used herein, foundational statistical principles refer to fundamental statistical concepts and/or methods that form a basis for more advanced statistical analyses. By way merely of example, in one or more embodiments, foundational statistical principles can include descriptive statistical measures that describe statistical properties of data such as, e.g., measures of central tendency (mean, median, etc.) and/or measures of dispersion (such as deviation of data from the average behavior, segmentation of data into multiple equal parts to dissect and analyze the distributions, etc.). Additionally or alternatively, foundational statistical principles can include at least one concept of probability distributions (e.g., Gaussian, log-normal, beta, gamma distributions, etc.) to fit and/or align data to at least one certain mathematical distribution framework for facilitating computations, analysis, inferencing, etc.

Also, as used herein, probability distributions refer to one or more mathematical functions that describe the likelihood of different outcomes in at least one random trial and/or experiment, and demand patterns refer to one or more general shapes and/or characteristics of resource demand over time, including, e.g., a lumpy demand pattern (e.g., sporadic bursts of resource demand), an intermittent demand pattern, an erratic demand pattern, and/or a smooth demand pattern.

Further, as used herein, distribution fitting refers to a process of finding and/or determining a probability distribution that best fits observed data, facilitating statistical analysis and modeling. As also used herein, statistical tests refer to procedures to assess the goodness of fit and/or similarity between observed and expected data distributions, and example statistical tests can include, e.g., Kolmogorov-Smirnov, Cramer-von-Mises, and Anderson-Darling tests. Additionally, as used herein, gamma distribution refers to a continuous probability distribution often used, e.g., to model positively skewed data, a Weibull distribution refers to a versatile continuous probability distribution commonly applied, e.g., in reliability engineering and survival analysis, a log-normal distribution refers to a probability distribution that is log-transformed normal, often used, e.g., to model positively skewed data, a beta distribution refers to a family of continuous probability distributions defined on the interval [0, 1], often used, e.g., for modeling proportions or probabilities, and a logistic distribution refers to a continuous probability distribution commonly used, e.g., to model binary outcomes and/or growth processes.

Also, as used herein, intermittent demand forecasting refers to methods designed for forecasting sporadic or irregular demand patterns, wherein demand occurs irregularly over time, and polynomial regression refers to at least one regression technique that fits a polynomial equation to data, allowing, e.g., for more complex relationships between variables.

Accordingly, one or more embodiments include combining one or more foundational statistics principles such as, for example, descriptive statistics for time series segmentation of a given set of resource-related time series data, with probability distribution fitting techniques for each segment of the given set of resource-related time series data. Based at least in part on one or more outputs of such a combination, at least one embodiment includes generating one or more resource forecasts from a given number of the probability distributions for each segment of the given set of resource-related time series data using at least one weighted average approach. Such an embodiment can also include combining at least a portion of these forecasts and the at least a portion of these forecasts to one or more future time indices using at least one non-linear regression technique.

In at least one embodiment, at least one empirical threshold, derived from at least one descriptive statistical method, is used to segment a given set of resource demand time series data into at least one high demand time series, at least one low demand time series, and/or at least one no demand time series. By way merely of example, descriptive statistical methods can include median measures, quartile measures, etc. Additionally, such an embodiment includes determining and/or selecting at least one probability distribution (e.g., the most probable probability distributions) that fit one or more of the time segments (e.g., each of the series segments) using one or more statistical tests such as, for example, the Kolmogorov-Smirnov test, the Anderson-Darling test, and/or the Cramer-von-Mises test. Determining and/or selecting at least one probability distribution can be carried out by incorporating different distributions such as, for example, a gamma distribution, a Weibull distribution, a log-normal distribution, a normal distribution, a logistic distribution, etc.

One or more embodiments can also include generating one or more resource demand forecasts based at least in part on the at least one determined and/or selected distribution and one or more corresponding parameters (e.g., shape, scale, etc.) as an extrapolation of the distribution values for the future for each segment. In such an embodiment, after determining and fitting the most probable distribution for the demand segment(s) and/or demand data, one or more statistical properties pertinent to the distribution that is specific to each probability distribution (such as, e.g., location, shape, scale, variance, etc.) are kept static, and one or more forecasts are randomly sampled from the pertinent distribution for a given number of future time periods.

By way of example, in such an embodiment, a low resource demand forecast, a no resource demand forecast, and a high demand resource forecast are combined and aligned to at least one given time index using at least one non-linear regression technique that models and predicts at least one relationship between the at least one time index and the low resource demand forecast and/or the no resource demand forecast. Accordingly, indices (e.g., positions) of the low demand and no demand data segments from the original demand series can be extracted that indicate periods of low demand and periods of no demand. Such indices are then mapped to an integer sequence (e.g., 1 . . . n) to determine and/or understand the relationship between time continuity and no demand/low demand occurrence period/time points. This relationship from the historical data can then be utilized to predict future time indices for when periods of low demand and/or no demand will occur for time index, thereby generating forecast alignment. For instance, if the low demand occurrences from historical data are associated with the first, second and fifth weeks, and if the no demand occurrences are associated with the third and fourth weeks, these week numbers are mapped to a time index sequence beginning at one and ending at the total number of low demand and/or no demand data points in the historical data, indicating time continuity. In one or more embodiments, a polynomial and/or non-linear regression model can be used, for example, to model the relationship between the low demand occurrence(s) and the time continuity to predict the low demand occurrence weeks and/or time points for the future.

Additionally, such data can be partitioned randomly in a ratio of approximately 80:20, with 80% of the low demand historical indices along with the time continuity indices used for training the polynomial and/or non-linear regression model. The remaining 20% of the data can then be used for validating the model to find the best parameters (such as, e.g., degree of polynomial). In at least one embodiment, a cross-validation method can be employed to determine the best degree of polynomial and/or non-linear regression for the data, and use the same degree for forecasting the future low demand occurrence periods. The low demand forecasts generated from the most probable distributions can then be mapped to these time periods. The remaining periods can be the no demand occurrence periods, and the corresponding demand forecasts generated from the most probable distributions are aligned to those time periods.

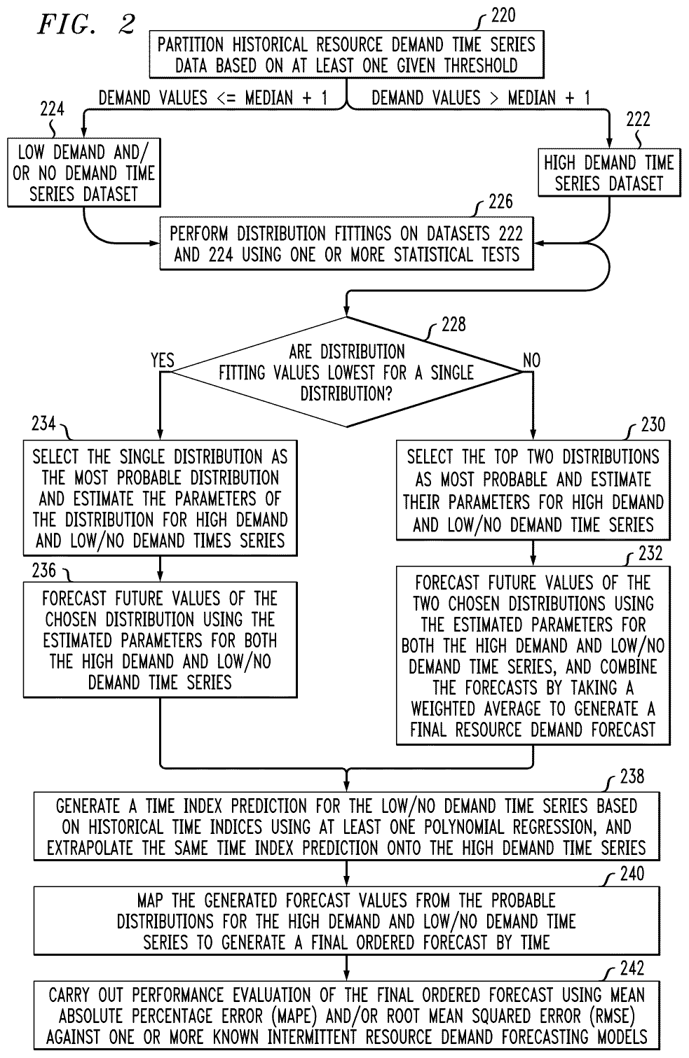

FIG. 2 shows an example workflow in an illustrative embodiment. By way of illustration, FIG. 2 depicts partitioning, in step 220, historical resource demand time series data based on at least one given threshold (e.g., median value+1) to create a high demand time series dataset 222 and a low demand and/or no demand time series dataset 224. Step 226 includes performing distribution fittings on datasets 222 and 224 using one or more statistical tests such as, e.g., Kolomogorov-Smirnov, Cramer-von Mises, Andersen-Darling, etc. Such statistical tests can be used to assess the goodness and/or appropriateness of fit of the probability distributions fitted to the low/no demand data and high demand data. The statistical tests can compare the theoretical probability distribution for each of the chosen distributions (such as, e.g., Gaussian, log-normal, beta, gamma, etc.) against the empirical distribution of the observed low/no demand data and high demand data. The corresponding test statistic can include the difference between this empirical distribution function (EDF) of the low/no demand data and high demand data and the cumulative distribution function (CDF) of the specified theoretical distribution. This comparison is referred to herein as the goodness of fit of distributions to the data. This measure can be augmented further with the use of Akaike information criterion (AIC) and Bayesian information criterion (BIC), which help compare the relative statistical quality of the distributions fitted to the data. Such measures also provide a way to numerically compare which probability distribution fits the data well, and the measures are relevant when the choice of distributions becomes unclear when using test statistics alone. For example, the distributions with lower AIC and BIC values are considered better because they either fit the data more closely or use fewer parameters to achieve a similar level of fit.

Step 228 includes determining whether the test statistic+AIC+BIC value(s) is the lowest for a single distribution. If no (that is, the test statistic+AIC+BIC value(s) is not the lowest for a single distribution), then step 230 includes choosing the top two distributions as most probable and estimating their parameters for high demand and low/no demand time series. If yes (that is, the test statistic+AIC+BIC value(s) is the lowest for a single distribution), then step 234 includes choosing the given/single distribution as the most probable distribution and separately estimating the parameters of the distribution for high demand and low/no demand time series.

Referring again to step 230, step 232 includes forecasting the future values of the two chosen distributions using the estimated parameters for both the high demand and low/no demand time series (e.g., wherein the time horizon equals n time periods in the future), and combining the forecasts by taking a weighted average to generate a final resource demand forecast (wherein the weights are based at least in part on test statistics from one or more statistical distribution tests). Referring again to step 234, step 236 includes forecasting the future values of the chosen distribution using the estimated parameters for both the high demand and low/no demand time series (e.g., wherein the time horizon equals n time periods in the future). Step 238 includes, using output(s) from step 232 and step 236, generating a time index prediction for the low/no demand time series based at least in part on historical time indices using at least one polynomial regression (wherein, e.g., the degree is chosen based on a k-fold cross-validation optimized on the mean absolute percentage error (MAPE)) and extrapolating the same time index prediction onto the high demand time series.

Additionally, step 240 includes mapping the generated forecast values from the noted probable distributions for the high demand and low/no demand time series to generate a final ordered forecast by time. In at least one embodiment, time indices (e.g., positions) of low demand and/or no demand series can be extracted from the historical data. For instance, if low demand periods based on chosen descriptive statistical threshold are associated with weeks two, four, five, and eight, these periods are mapped to a time continuity index sequence (e.g., 1, 2, 3, 4, . . . total number of low demand data points). These low demand occurrence indices and the time continuity index can be modeled as a non-linear and/or polynomial regression problem as the occurrence of demand versus time continuity (e.g., every week, day and/or month). The best degree of the polynomial function can be determined using cross-validation on, for example, a randomly sampled 20% of the historical low demand data subset, and this degree is used for generating low demand occurrence indices for the future to map the generated low demand forecasts from the top n most probable distributions to each of these forecasted low demand occurrence indices. These indices can be considered beyond the maximum value of the high demand series and/or data indices. For example, assume that the forecasted indices for a low demand series are 80, 83, and 88, and the total number of demand data values in the original demand series is 82. Then, the forecasted indices greater than the total number of high demand series are considered for mapping the forecasts to these future indices, which in this case will be 83 and 88. The gap between 83 and 88 (that is, 84, 85, 86, and 87) are all mapped to no demand forecasts in the same order, and the remaining no demand forecasts will be aligned to indices beyond 88 in the order of the no demand forecasts appearance until the end of the forecast period.

Further step 242 includes carrying out at least one performance evaluation of the final ordered forecast using MAPE and/or the root mean squared error (RMSE) against one or more known intermittent resource demand forecasting models.

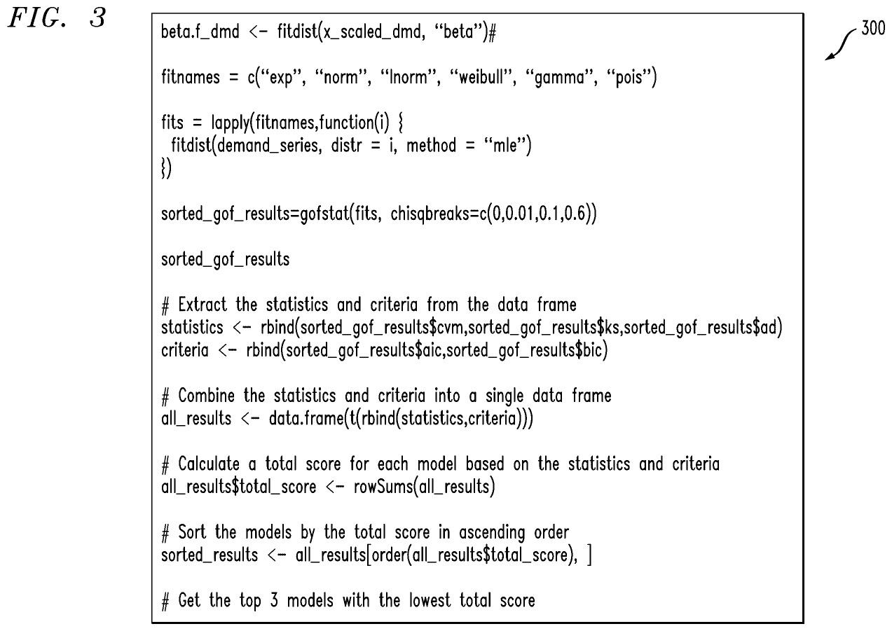

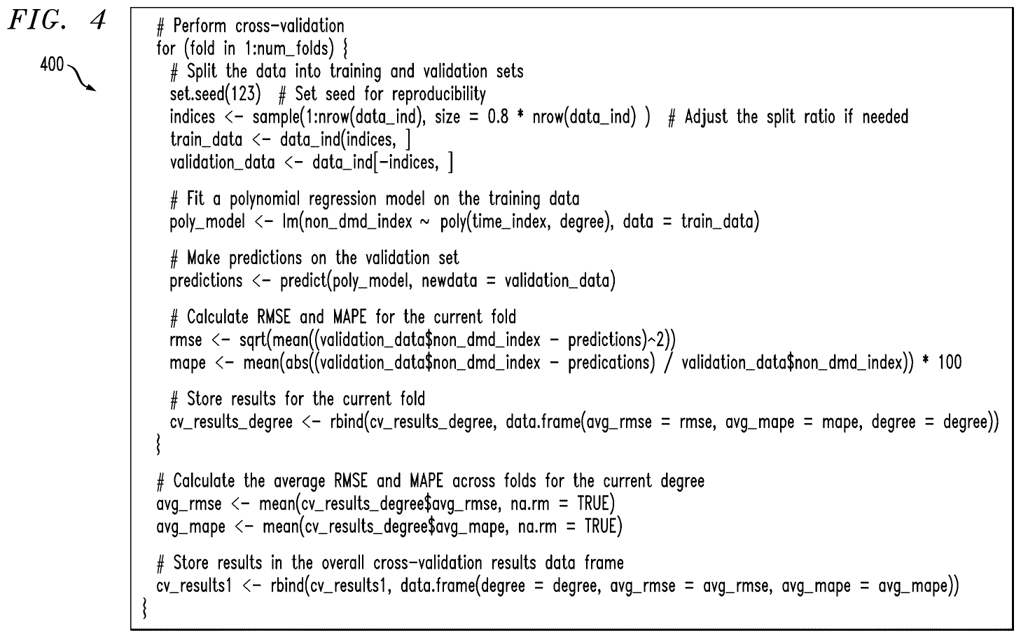

By way of example (such as, for instance, further detailed in connection with FIG. 3 and FIG. 4), at least one embodiment includes using R programming language and implementing as a library and/or package that can be imported and invoked for any time series forecasting purposes.

FIG. 3 shows example pseudocode for processing distribution models in an illustrative embodiment. In this embodiment, example pseudocode 300 is executed by or under the control of at least one processing system and/or device. For example, the example pseudocode 300 may be viewed as comprising a portion of a software implementation of at least part of automated resource forecasting system 105 of the FIG. 1 embodiment.

The example pseudocode 300 illustrates extracting statistics and given criteria from at least one given data frame, combining at least a portion of the statistics and at least a portion of the given criteria into a single data frame, and calculating a total score for each of multiple given probability models based at least in part on the at least a portion of the statistics and the at least a portion of the given criteria. Further, example pseudocode 300 illustrates sorting the multiple given probability models by total score, in ascending order. Also, example pseudocode 300 illustrates identifying the top three probability models having the lowest total score(s).

It is to be appreciated that this particular example pseudocode shows just one example implementation of processing distribution models, and alternative implementations can be used in other embodiments.

FIG. 4 shows example pseudocode for validating forecasting predictions in an illustrative embodiment. In this embodiment, example pseudocode 400 is executed by or under the control of at least one processing system and/or device. For example, the example pseudocode 400 may be viewed as comprising a portion of a software implementation of at least part of automated resource forecasting system 105 of the FIG. 1 embodiment.

The example pseudocode 400 illustrates performing cross-validation steps which include splitting a given set of data into training and validation datasets, fitting at least one polynomial regression model on the training dataset, generating one or more predictions on the validation dataset, calculating the RMSE and the MAPE for a given forecast or fold, and storing results for the given forecast or fold. Also, example pseudocode 400 illustrates calculating the average RMSE and the average MAPE across multiple forecasts or folds for the given degree, and storing such results in an overall cross-validation results data frame.

It is to be appreciated that this particular example pseudocode shows just one example implementation of validating forecasting predictions, and alternative implementations can be used in other embodiments.

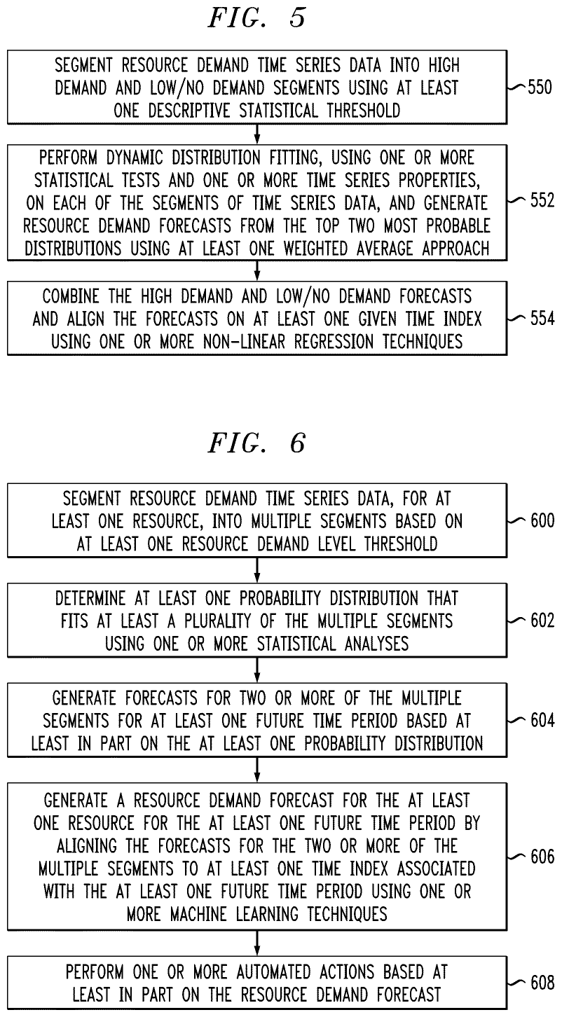

FIG. 5 shows an example workflow in an illustrative embodiment. By way of illustration, step 550 includes segmenting resource demand time series data, e.g., into high demand and low/no demand segments, using at least one descriptive statistical threshold. Step 552 includes performing dynamic distribution fitting, using one or more statistical tests and one or more time series properties, on each of the segments of time series data. Also, step 552 includes generating resource demand forecasts from the top two most probable distributions using at least one weighted average approach. Further, step 554 includes combining the high demand and low/no demand forecasts and aligning the forecasts on at least one given time index using one or more non-linear regression techniques.

As detailed herein, one or more embodiments include using one or more descriptive statistics-based thresholds to segment a given set of resource demand time series data. Such an embodiment also includes fitting one or more probability distributions for each segment to generate one or more resource demand forecasts for one or more future temporal windows. Additionally, such an embodiment includes integrating at least a portion of the generated forecasts and aligning the at least a portion of the generated forecasts to at least one continuous time index in the future using at least one non-linear regression model.

By segmenting the resource demand time series data using one or more descriptive statistics-based thresholds, one or more embodiments can include handling varying demand and/or time series patterns in the historical data. Such a threshold can be determined and/or selected empirically after experimenting with various descriptive statistical measures. As detailed herein, descriptive statistical measures that describe statistical characteristics of data such as, e.g., mean, median, variance, standard deviation, inter-quartile range, percentile ranks, etc., can be leveraged to empirically determine which metric works the best for splitting and determining the most probable distributions for the given data. For example, while mean and median can help segment data above and below where the average behavior of the data lies, inter-quartile range can help split data into segments to understand how the data is distributed around and away from the average and/or central value while being robust to extreme values in the data. For determining the best descriptive statistical method and the best threshold for the given data, a series of experiments can be carried out using at least a portion of the aforementioned metrics and a range of values from the data.

In at least one embodiment, a factor (e.g., a factor of one) can be added to the median value of the historical data to facilitate distribution fitting if the historical data contains only zero values in the data series. This can be a configurable value which is empirically determined using aforementioned descriptive statistical methods and/or experiments. Each series can then be modeled using one or more statistical distributions in a dynamic manner to determine the top-k probable distributions (e.g., the top two probable distributions) based at least in part on one or more statistical tests such as, e.g., the Kolmogorov-Smirnov test, the Anderson-Darling test, the Cramer-von-Mises test, etc.

Additionally or alternatively, in one or more embodiments, a weighted average approach can be used to honor the probability distribution assumptions in cases wherein there is no single distribution that fits the data accurately and/or sufficiently. Also, in such an embodiment, the forecast generated from the most probable distribution determined based on the statistical tests receives the highest weightage, and the forecast generated from the second best/highest distribution receives the remaining weightage (e.g., the first best weightage deducted from 100%). As further detailed herein, the temporal coherence of the historical data series can be maintained and reinforced at the time of combining the low demand series, the no demand series and the high demand series by employing at least one polynomial regression technique that captures one or more non-linear relationships between time continuity and the demand quantity itself.

At least one embodiment includes generating non-constant forecasts with non-zero variance, unlike conventional resource forecasting techniques which typically provide constant forecasts with zero variance for future time periods. Combining no demand forecast series and/or low demand forecast series with high demand forecast series, with attention to time index alignment and mapping for the future, captures differentiation between no and/or low demand at certain time points and the presence of good and/or high demand at certain time points. The segmentation and/or splitting of a high demand series into no demand and low demand segments based on a descriptive statistical threshold facilitates the fitting of one or more distinct probability distributions that describe the segments well with their own statistical properties and/or parameters (e.g., mean, variance, location, scale, shape, etc.). Random sampling from these probable distributions for generating future forecasts for each segment can give rise to a low demand series with non-zero non-constant values, and a no demand forecast with zero or near-zero values for the future. These forecasts can be stitched back together with time index alignment for the forecast period using polynomial and/or non-linear regression techniques in connection with low demand and/or no demand occurrence versus time continuity mapping techniques. The final forecast series, therefore, does not have values that are constant with zero variance and that is where the differentiation can reside. Accordingly, such an embodiment can be used, for example, to accurately forecast non-smooth demand patterns.

Additionally, one or more embodiments improve upon conventional resource forecasting techniques by forecasting when there will be demand for at least one given resource and when there will not be demand for the at least one given resource in at least one future time period. Accordingly, such an embodiment can serve as a single adaptive technique to comprehensively model and/or forecast multiple varieties of resource demand patterns, including erratic and/or irregular resource demand patterns. Further, at least one embodiment can include generating and/or implementing one or more resource demand forecasts in conjunction with a set of one or more additional forecasting approaches, providing a more comprehensive toolkit for generating forecasts.

By way merely of illustration, consider an example use case wherein laptop and/or server parts demand forecasting can be carried out for parts with varying lifetimes, wherein such varying lifetimes can have a direct impact with respect to cost and one/or more relevant resource-related activities. Demand for relatively new parts (e.g., less than approximately six months old), sustainable parts (e.g., those having consistent demand), and parts reaching end of life can all be forecasted accurately using one or more embodiments, which can capture one or more nuances in the lifecycles of such temporally variable parts.

Accordingly, as detailed herein, one or more embodiments include providing resource demand forecasting techniques suitable, for example, for resource quantity forecast generation that includes varying patterns (e.g., a lumpy pattern, an intermittent pattern, an erratic pattern, and/or a smooth pattern) based at least in part on variability in time and/or quantity parameters.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on historical resource demand data and/or related time series data, and such recommendations and/or predictions can be used to initiate one or more automated actions (e.g., automatically initiating resource implementation actions such as manufacturing the resource, transmitting the resource, etc., as well as automatically retraining the model used to generate the recommendations and/or predictions). Additionally or alternatively, the recommendations and/or predictions can be used to initiate one or more automated actions such as one or more resource inventory planning actions (e.g., setting safety stock levels driving risk management in inventory planning), determining optimal service levels by balancing the cost of holding excess inventory versus the risk of stock outs, determining product phase out decisions and/or resource supplier selections to reduce lead times, etc.

FIG. 6 is a flow diagram of a process for automated resource forecasting using statistical analysis and machine learning techniques in an illustrative embodiment. It is to be understood that this particular process is only an example, and additional or alternative processes can be carried out in other embodiments.

In this embodiment, the process includes steps 600 through 608. These steps are assumed to be performed by the automated resource forecasting system 105 utilizing elements 112, 114, 116 and 118.

Step 600 includes segmenting resource demand time series data, for at least one resource, into multiple segments based on at least one resource demand level threshold. In one or more embodiments, segmenting resource demand time series data includes segmenting resource demand time series data into at least one segment containing resource demand data above the at least one resource demand level threshold and at least one segment containing resource demand data below the at least one resource demand level threshold, and wherein the at least one resource demand level threshold is derived from one or more descriptive statistical techniques.

Step 602 includes determining at least one probability distribution that fits at least a plurality of the multiple segments using one or more statistical analyses. In at least one embodiment, determining at least one probability distribution that fits at least a plurality of the multiple segments includes using one or more of at least one Kolmogorov-Smirnov test, at least one Anderson-Darling test, and at least one Cramer-von-Mises test. Additionally or alternatively, determining at least one probability distribution that fits at least a plurality of the multiple segments can include determining at least one of multiple probability distributions that fits the at least a plurality of the multiple segments, wherein the multiple probability distributions comprises at least one gamma distribution, at least one Weibull distribution, at least one log-normal distribution, at least one normal distribution, and at least one logistic distribution.

Step 604 includes generating forecasts for two or more of the multiple segments for at least one future time period based at least in part on the at least one probability distribution. In one or more embodiments, generating forecasts for two or more of the multiple segments includes extrapolating distribution values, in accordance with the at least one probability distribution, for the at least one future time period for each of the two or more of the multiple segments.

Step 606 includes generating a resource demand forecast for the at least one resource for the at least one future time period by aligning the forecasts for the two or more of the multiple segments to at least one time index associated with the at least one future time period using one or more machine learning techniques. In at least one embodiment, aligning the forecasts for the two or more of the multiple segments to at least one time index associated with the at least one future time period includes using at least one non-linear regression model. Additionally or alternatively, generating forecasts for two or more of the multiple segments can include using at least one weighted average approach a weighted average approach in connection with two or more probability distributions.

Step 608 includes performing one or more automated actions based at least in part on the resource demand forecast. In one or more embodiments, performing one or more automated actions includes automatically training at least a portion of the one or more machine learning techniques using feedback related to at least a portion of the resource demand forecast. Additionally or alternatively, performing one or more automated actions can include automatically initiating one or more resource implementation actions in accordance with the resource demand forecast.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate resource demand forecasts using a combination of statistical analysis and machine learning techniques. These and other embodiments can effectively overcome problems associated with errors, inaccuracies, and resource wastage and/or loss.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

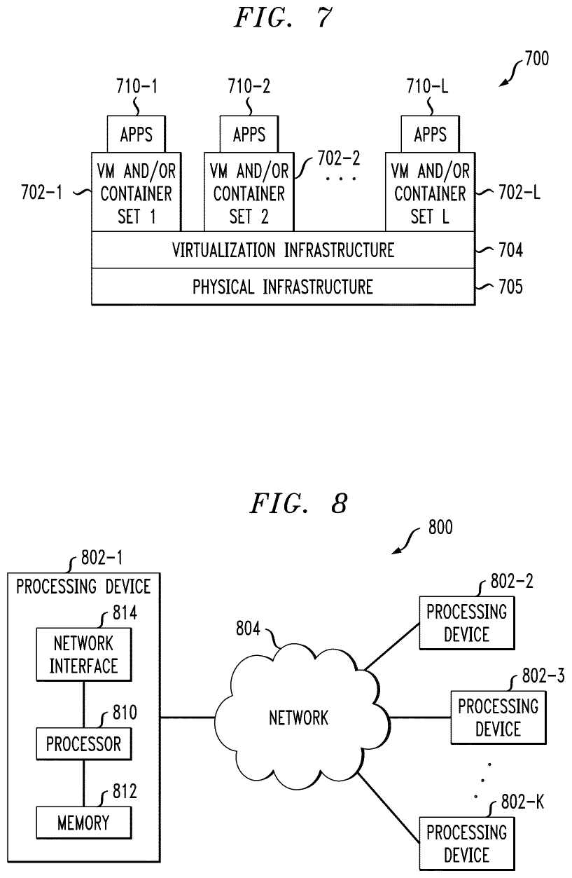

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a CPU, a GPU, a TPU, a microcontroller, an ASIC, a FPGA or other type of processing circuitry, as well as portions or combinations of such circuitry elements.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
segmenting resource demand time series data, for at least one resource, into multiple segments based on at least one resource demand level threshold;
determining at least one probability distribution that fits at least a plurality of the multiple segments using one or more statistical analyses;
generating forecasts for two or more of the multiple segments for at least one future time period based at least in part on the at least one probability distribution;
generating a resource demand forecast for the at least one resource for the at least one future time period by aligning the forecasts for the two or more of the multiple segments to at least one time index associated with the at least one future time period using one or more machine learning techniques; and
performing one or more automated actions based at least in part on the resource demand forecast;
wherein the method is performed by at least one processing device comprising a processor coupled to a memory.

2. The computer-implemented method of claim 1, wherein aligning the forecasts for the two or more of the multiple segments to at least one time index associated with the at least one future time period comprises using at least one non-linear regression model.

3. The computer-implemented method of claim 1, wherein segmenting resource demand time series data comprises segmenting the resource demand time series data into at least one segment containing resource demand data above the at least one resource demand level threshold and at least one segment containing resource demand data below the at least one resource demand level threshold, and wherein the at least one resource demand level threshold is derived from one or more descriptive statistical techniques.

4. The computer-implemented method of claim 1, wherein generating forecasts for two or more of the multiple segments comprises extrapolating distribution values, in accordance with the at least one probability distribution, for the at least one future time period for each of the two or more of the multiple segments.

5. The computer-implemented method of claim 1, wherein determining at least one probability distribution that fits at least a plurality of the multiple segments comprises using one or more of at least one Kolmogorov-Smirnov test, at least one Anderson-Darling test, and at least one Cramer-von-Mises test.

6. The computer-implemented method of claim 1, wherein determining at least one probability distribution that fits at least a plurality of the multiple segments comprises determining at least one of multiple probability distributions that fits the at least a plurality of the multiple segments, wherein the multiple probability distributions comprises at least one gamma distribution, at least one Weibull distribution, at least one log-normal distribution, at least one normal distribution, and at least one logistic distribution.

7. The computer-implemented method of claim 1, wherein generating forecasts for two or more of the multiple segments comprises using at least one weighted average approach a weighted average approach in connection with two or more probability distributions.

8. The computer-implemented method of claim 1, wherein performing one or more automated actions comprises automatically training at least a portion of the one or more machine learning techniques using feedback related to at least a portion of the resource demand forecast.

9. The computer-implemented method of claim 1, wherein performing one or more automated actions comprises automatically initiating one or more resource implementation actions in accordance with the resource demand forecast.

10. A non-transitory processor-readable storage medium having stored therein program code of one or more software programs, wherein the program code when executed by at least one processing device causes the at least one processing device:
to segment resource demand time series data, for at least one resource, into multiple segments based on at least one resource demand level threshold;
to determine at least one probability distribution that fits at least a plurality of the multiple segments using one or more statistical analyses;
to generate forecasts for two or more of the multiple segments for at least one future time period based at least in part on the at least one probability distribution;
to generate a resource demand forecast for the at least one resource for the at least one future time period by aligning the forecasts for the two or more of the multiple segments to at least one time index associated with the at least one future time period using one or more machine learning techniques; and
to perform one or more automated actions based at least in part on the resource demand forecast.

11. The non-transitory processor-readable storage medium of claim 10, wherein aligning the forecasts for the two or more of the multiple segments to at least one time index associated with the at least one future time period comprises using at least one non-linear regression model.

12. The non-transitory processor-readable storage medium of claim 10, wherein segmenting resource demand time series data comprises segmenting the resource demand time series data into at least one segment containing resource demand data above the at least one resource demand level threshold and at least one segment containing resource demand data below the at least one resource demand level threshold, and wherein the at least one resource demand level threshold is derived from one or more descriptive statistical techniques.

13. The non-transitory processor-readable storage medium of claim 10, wherein generating forecasts for two or more of the multiple segments comprises extrapolating distribution values, in accordance with the at least one probability distribution, for the at least one future time period for each of the two or more of the multiple segments.

14. The non-transitory processor-readable storage medium of claim 10, wherein determining at least one probability distribution that fits at least a plurality of the multiple segments comprises using one or more of at least one Kolmogorov-Smirnov test, at least one Anderson-Darling test, and at least one Cramer-von-Mises test.

15. The non-transitory processor-readable storage medium of claim 10, wherein determining at least one probability distribution that fits at least a plurality of the multiple segments comprises determining at least one of multiple probability distributions that fits the at least a plurality of the multiple segments, wherein the multiple probability distributions comprises at least one gamma distribution, at least one Weibull distribution, at least one log-normal distribution, at least one normal distribution, and at least one logistic distribution.

16. An apparatus comprising:
at least one processing device comprising a processor coupled to a memory;
the at least one processing device being configured:
to segment resource demand time series data, for at least one resource, into multiple segments based on at least one resource demand level threshold;
to determine at least one probability distribution that fits at least a plurality of the multiple segments using one or more statistical analyses;
to generate forecasts for two or more of the multiple segments for at least one future time period based at least in part on the at least one probability distribution;
to generate a resource demand forecast for the at least one resource for the at least one future time period by aligning the forecasts for the two or more of the multiple segments to at least one time index associated with the at least one future time period using one or more machine learning techniques; and
to perform one or more automated actions based at least in part on the resource demand forecast.

17. The apparatus of claim 16, wherein aligning the forecasts for the two or more of the multiple segments to at least one time index associated with the at least one future time period comprises using at least one non-linear regression model.

18. The apparatus of claim 16, wherein segmenting resource demand time series data comprises segmenting the resource demand time series data into at least one segment containing resource demand data above the at least one resource demand level threshold and at least one segment containing resource demand data below the at least one resource demand level threshold, and wherein the at least one resource demand level threshold is derived from one or more descriptive statistical techniques.

19. The apparatus of claim 16, wherein generating forecasts for two or more of the multiple segments comprises extrapolating distribution values, in accordance with the at least one probability distribution, for the at least one future time period for each of the two or more of the multiple segments.

20. The apparatus of claim 16, wherein determining at least one probability distribution that fits at least a plurality of the multiple segments comprises using one or more of at least one Kolmogorov-Smirnov test, at least one Anderson-Darling test, and at least one Cramer-von-Mises test.
